(19) United States
(12) Patent Application Publication
(10) Pub. No.: US 2019/0087212 A1
(43) Pub. Date: Mar. 21, 2019

(54) ANDROID SIMULATOR AND METHOD FOR IMPLEMENTING ANDROID SIMULATOR

(71) Applicant: BEIJING QIHOO TECHNOLOGY COMPANY LIMITED, Beijing (CN)

(72) Inventors: Han YAN, Beijing (CN); Xin RAN, Beijing (CN); Zhihui LIANG, Beijing (CN)

(21) Appl. No.: 15/741,186

(22) PCT Filed: Nov. 1, 2016
(86) PCT No.: PCT/CN2016/104236

§ 371 Date: Dec. 29, 2017

(30) Foreign Application Priority Data
Aug. 10, 2016 (CN) 201610652847.7

(51) Int. Cl. G06F 9/455

(52) U.S. Cl. CPC G06F 9/45537; G06F 2009/45579; G06F 2009/45583; G06F 9/45558

(57) ABSTRACT

An Android simulator and a method for implementing an Android simulator are provided, wherein the Android simulator comprises an Android virtual machine and an application running module; the Android virtual machine comprises a data converting unit and a running unit, wherein the data converting unit is configured to convert a data structure of Linux-based Android-related data to a data structure of Windows-based Windows-related data; the running unit is configured to establish and manage a thread and a signal of the Linux system in the Windows system, and manage a memory allocation of the Linux system in the Windows system; and the application running module is configured to run an application in the Android virtual machine running module.

### FIELD OF TECHNOLOGY

The present invention relates to the field of computer technologies, and in particular, to an Android simulator, a method for implementing an Android simulator, a computer program and a computer-readable medium.

### BACKGROUND

With constant development of computer technologies, in daily lives, people increasingly rely on various applications, and people's usage requirements for the applications are also increasingly diversified. When users use game applications on mobile terminals of Android operating systems, the users expect to realize operation experiences of the applications in personal computers (PCs) of Windows operating systems, so that the users can enjoy more convenient and more smooth operation experiences on larger display screens, thereby solving a problem of poor visual experience due to smaller screens of the mobile terminals. Meanwhile, it is avoidable that game halt is caused by overheating of processors of the mobile terminals, and it is avoidable that the users' game control is interrupted by unstable network signal of the mobile terminals.

In the prior art, first of all, a virtual machine needs to be installed on a PC of the Windows operating system, a virtual Android operating system is operated in the virtual machine, and later an Android application is installed and run in the virtual Android operating system. In one aspect, in the process of installing a virtual machine, a complete set of kernel-level drivers of the virtual machine may be installed; and in the running process of an application, invoking each kernel driver is extremely complex, and system resources are consumed. In another aspect, the running of the virtual machine needs to consume a large amount of hard disk space and a memory of a PC, which may reduce a response speed of running of each process of the PC. In still another aspect, the implementation of the prior art is greatly dependent on virtualized hardware acceleration techniques of a central processing unit (CPU) of the PC. Over the past few decades, rapid popularization of hardware virtualization technologies makes computer performance better and better. However, to avoid the occurrence of various potential safety hazards, after manufacturing of more than 70% of main boards is completed, implementation of the hardware virtualization technologies is prohibited in the basic input output system (BIOS). Consequently, a large number of users' demands cannot be satisfied, and thus the user experience is reduced. Further, the virtual machine essentially is provided to business users and geek users having professional knowledge for use, which may bring great operation difficulties to ordinary users in a using process, thereby limiting the development of user groups.

### SUMMARY

To overcome the aforementioned problems or at least in part solving the aforementioned problems, following technical solutions are particularly proposed.

An embodiment of the present invention provides an Android simulator, including an Android virtual machine and an application running module.

The Android virtual machine includes a data converting unit and a running unit; wherein

the data converting unit is configured to convert a data structure of Linux-based Android-related data to a data structure of Windows-based Windows-related data; and
the running unit is configured to establish and manage a thread and a signal of the Linux system in the Windows system, and manage a memory allocation of the Linux system in the Windows system.

The application running module is configured to run an application in the Android virtual machine running module.

Another embodiment of the present invention provides a method for implementing an Android simulator, comprising:

converting a data structure of Linux-based Android-related data to a data structure of Windows-based Windows-related data;
establishing and processing a corresponding signal of the Linux system in the Windows system, managing a memory allocation of the Linux system in the Windows system, and running an Android virtual machine in the Windows system; and
running an application in the Android virtual machine.

An embodiment of the present invention further provides a computer program, including a computer-readable code, wherein a computing device is caused to execute the method for implementing an Android simulator according to any one of the embodiments of the present invention when the computer-readable code runs on the computing device.

An embodiment of the present invention further provides a computer-readable medium, in which the program of the embodiment of the present invention is stored.

An embodiment of the present invention provides an Android simulator, including: an Android virtual machine and an application running module, wherein the Android virtual machine includes a data converting unit and a running unit. The data converting unit is configured to convert a data structure of Linux-based Android-related data to a data structure of Windows-based Windows-related data to implement normal and convenient data communication between an Android operating system and a Windows operating system, thereby avoiding a data error caused by a complex conversion mode and providing important premise and guarantee for normal running of an application. The running unit is configured to establish and manage a thread and a signal of the Linux system in the Windows system, and manage a memory allocation of the Linux system in the Windows system, so that it is thoroughly implemented that an Android application properly runs in the Windows system in the form of a native application, and it is implemented that less system resources are occupied in the running process of the Android application, thereby solving the problems of sluggish or slow running of the Android application in the Windows system. The application running module is configured to run an application in the Android virtual machine running module, so that normal and fast running of the Android application in the Windows system may be implemented without users' complex operations, thereby further improving user experience.

Additional aspects and advantages of the present invention will be set forth in the description which follows and will be apparent from the description, or may be learned by practice of the present invention.

### BRIEF DESCRIPTION OF THE DRAWINGS

The above and/or additional aspects and advantages of the present invention will become apparent and readily comprehensible from the following description of embodiments with reference to the accompanying drawings, in which,

FIG. 1 is a schematic structural diagram of an Android simulator according to an embodiment of the present invention;

FIG. 2 is a flowchart of a method for implementing an Android simulator according to another embodiment of the present invention;

FIG. 3 is a block diagram of a computing device for executing the method for implementing an Android simulator according to the present invention; and

FIG. 4 is a memory unit for maintaining or carrying a program code for implementing the method for implementing an Android simulator according to the present invention.

### DESCRIPTION OF THE EMBODIMENTS

The embodiments of the present invention will be described in detail as below. Examples of the embodiments are as shown in drawings, in which same or similar reference numbers always represent same or similar elements or elements with same or similar functions. The embodiments described with reference to the drawings are exemplary, just used for explaining the present invention, not for limiting the present invention.

A person skilled in the art may understand that “a”, “an”, “said” and “the” used herein may also refer to plural nouns, unless otherwise specifically stated. It should be further understood that, phraseology “include” used in the specification of the present invention refers to the presence of the characteristics, integers, steps, operations, elements and/or components, but not exclusive of the presence or addition of one or more other characteristics, integers, steps, operations, elements, components and/or groups thereof. It should be understood that when we mention that an element is “connected” or “coupled” to another element, it may be directly connected or coupled to the other elements, or intermediate elements may be available. In addition, “connection” or “coupling” used herein may include wireless connection or coupling. The phraseology “and/or” used herein includes any one unit and all combinations of one or more associated listed items.

A person skilled in the art may understand that, unless otherwise defined, all terms (including technical terms and scientific terms) used herein have the same meaning as commonly understood by an ordinary person skilled in the art to which the present invention belongs. It should also be understood that terms such as those defined in commonly used dictionaries should be interpreted as having a meaning that is consistent with their meaning in the context of the prior art, and will not be interpreted in an idealized or overly formal sense unless expressly so defined herein.

FIG. 1 is a schematic structural diagram of an Android simulator according to an embodiment of the present invention.

In the embodiment of the present invention, contents executed by modules are outlined as below: an Android virtual machine 110 and an application running module 120 are provided, wherein the Android virtual machine 110 includes a data converting unit 111 and a running unit 112. The data converting unit 111 is configured to convert a data structure of Linux-based Android-related data to a data structure of Windows-based Windows-related data. The running unit 112 is configured to establish and manage a corresponding signal of the Linux system in the Windows system, and manage a memory allocation of the Linux system in the Windows system. The application running module 120 is configured to run an application in the Android virtual machine running module.

An embodiment of the present invention provides an Android simulator, including: an Android virtual machine and an application running module, wherein the Android virtual machine includes a data converting unit and a running unit. The data converting unit is configured to convert a data structure of Linux-based Android-related data to a data structure of Windows-based Windows-related data to implement normal and convenient data communication between an Android operating system and a Windows operating system, thereby avoiding a data error caused by a complex conversion mode and providing important premise and guarantee for normal running of an application. The running unit is configured to establish and manage a thread and a signal of the Linux system in the Windows system, and manage a memory allocation of the Linux system in the Windows system, so that it is thoroughly implemented that an Android application properly runs in the Windows system in the form of a native application, and it is implemented that less system resources are occupied in the running process of the Android application, thereby solving the problems of sluggish or slow running of the Android application in the Windows system. The application running module is configured to run an application in the Android virtual machine running module, so that normal and fast running of the Android application in the Windows system may be implemented without users' complex operations, thereby further improving user experience. Concrete implementation of each module is further described as below.

The Android virtual machine 110 includes the data converting unit 111 and the running unit 112.

The data converting unit 111 converts a data structure of Linux-based Android-related data to a data structure of Windows-based Windows-related data.

It is to be noted that those skilled in the art may realize that a C runtime library developed by Microsoft is used for development and running of an operating system under a Windows platform. Generally, a C runtime function (CRT function) is a standard C language function. Later, a C++ runtime library is developed on this basis. Therefore, the CRT in the prior art refers to the C/C++ runtime library developed by Microsoft. For example, functions such as printf, scanf, strlen, fopen and so on belong to CRT functions. All CRT functions in Windows are finally converted to Win32 APIs for execution. The Windows itself does not provide support for the CRT above a kernel. The CRT may be implemented by a static linking or a dynamic linking.

Android is an operating system based on a Linux kernel. Therefore operations in an Android operating system may relate to Linux-related operations. For example, a data structure in the Android operating system is a data structure of the Linux, and a signal management mechanism in the Android operating system is a signal management mechanism in the Linux and so on. Meanwhile, since the Android is an operating system based on the Linux kernel, reference is made to implementations of a Linux system or an OpenBSD system for implementations of CRT interfaces on a bottom layer of the Android operating system, and a majority of CRT interfaces on the bottom layer of the Android operating system conform to POSIX/Linux/OpenBSD standards, but some CRT interfaces on the bottom layer are implemented in a customized way and do not conform to the above standards. These CRT interfaces may be collectively referred to as interfaces conforming to “Android system standards”.

For example, for the Android simulator running on the Windows operating system in this embodiment, since the Android simulator is developed based on the Linux operating system, POSIX and OpenBSD standards or the like need to be implemented for the CRT on the Windows operating system. Also since the data structure of the Linux operating system is different from that of the Windows operating system, the data structure of the Linux-based Android-related data needs to be converted to the data structure of Windows-based Windows-related data. For example, an address of a corresponding function is searched, by a function name, from a so library and a customized CRT function table loaded by loading a Linux executable file of a predetermined format such as a relevant file of an ELF format. The function is directly invoked if it is a function in the so library; if the function is a customized CRT function, the customized function is invoked. The implementation method for searching an address of a corresponding function by a function name includes: converting an Android data structure to an intermediate data structure compatible with Windows standards, invoking a Windows interface to implement a function performance, later converting a returned value to the Android data structure, and finally implementing data communication between the Android simulator and the Windows operating system through a CRT-related interface to implement normal running of the Android virtual machine (for example, a Java virtual machine Dalvik implemented by Google for use by the Android system) on the Windows operating system.

In this embodiment, the Android virtual machine runs on the Windows operating system in a sandbox running environment. It is to be noted that those skilled in the art may realize that there are different implementations for the Android virtual machine running on the Windows operating system, which may be implemented in a specific way but may be not limited in the present invention.

Preferably, the Android virtual machine 110 loads a Linux executable file of a predetermined format, and loads relevant files of the Android system and of a dynamic link library of the application.

For example, an application layer of the Android operating system is written by using a Java language. Therefore, in a running process of the Android virtual machine, Java-related files may be loaded. When an APP1 runs in the Android virtual machine, a relevant essential library of the Android virtual machine is first loaded after the Android virtual machine runs, such as a customized CRT-related library of the Android virtual machine, including interfaces having implemented libc.so, OpenGL ES interfaces, OpenSL ES interfaces and a part of Android Native Development Kit (Android NDK) interfaces or the like. Later, by loading a Linux executable file of a predetermined format, such as a relevant file of an ELF format, the Android virtual machine loads relevant files of the Android system and of a dynamic link library of the APP1, for example, relevant .so files of a system library of the Android system, relevant .so files of the APP1, and relevant files of a math library libm.so, etc.

The running unit 112 establishes and processes a corresponding signal of the Linux system in the Windows system, and manages a memory allocation of the Linux system in the Windows system.

Preferably, the running unit includes a signal processing unit, wherein the signal processing unit determines whether to perform signal processing on a currently running thread and a correlation function in the Android simulator based on a preset configuration parameter.

A corresponding Linux signal and a signal processing function are added into the currently running thread and the correlation function if the determination result is yes.

A signal processing function is invoked via a predetermined interface of the data converting module according to the corresponding Linux signal of the currently running thread.

The currently running thread includes a thread generated by the Android virtual machine and by the application during a running process, and the correlation function includes but is not limited to a correlation function according with the POSIX standard.

It is to be noted that in computer science, signaling is a limited manner for interprocess communication in a Unix operating system, a Unix-like operating system and other POSIX-compliant operating systems, and is an asynchronous notification mechanism for reminding a process of an event having already occurred. When a signal is sent to a process, an operating system interrupts a normal control flow of the process, and at the moment, any non-atomic operation may be interrupted. If a processing function of the signal is defined by the process, the processing function may be executed. Otherwise, a default processing function may be executed.

In the Linux operating system, there are many reasons for sending a signal. For example, a signal related to process termination may be sent out when a process exits or a subprocess terminates. When a nonexistent system invocation is executed, a signal related to a nonanticipating error condition encountered when executing the system invocation may be sent out. The process may be informed of an asynchronous event occurring by sending a soft interrupt signal by a system invocation of a Kill function among processes in a user mode, etc. For example, the Android virtual machine Dalvik has been connected with a cross-platform open thread library such as PD632. A user presets a signal invoked in the running process of a thread1 in an application APP1 running in the Android virtual machine Dalvik, and later registers a signal-related processing function in the APP1. Each signal in the Linux operating system has a number and a macro definition name. The thread1 is generated when the APP1 is running in the Windows operating system via the Dalvik, later a CRT-related interface may determine whether a signal processing is performed on the currently running thread1 in the Dalvik according to the number and the name of the received signal of the thread1, later the signal-related processing function is added into the currently running thread1 in the Windows operating system, and later the thread library PD632 is invoked by the CRT-related interface, and the execution of the thread1 is completed according to the signal-related processing function.

For another example, the user presets a signal invoked in the running process of the thread1 in the APP1 running in the Android virtual machine Dalvik, later the CRT-related interface may determine whether a signal processing is performed on the currently running thread1 in the Dalvik according to the number and the name of the received signal of the thread1, later correlation functions at the bottom layer of the Windows operating system are invoked in the Windows operating system, for example, the currently running thread1 is paused, the signal-related processing function is added into the thread1, later the running of the thread1 is resumed, the thread library PD632 is invoked by the CRT-related interface, and the execution of the thread1 is completed according to the signal-related processing function.

Preferably, the running unit 112 includes a memory management unit (not shown in the figures), wherein the memory management unit implements a memory management interface of the Linux system based on a management mode of a virtual memory of the Windows system.

The memory management unit manages a memory allocation of the Linux system in the Windows system via the memory management interface based on a Windows-related interface and a predetermined memory allocation algorithm.

A virtual memory management mechanism in the Linux operating system is different from that in the Windows operating system, for example, the Linux operating system has mmap series interfaces, but the Windows operating system has VirtualAlloc series interfaces for virtual memory management and MapViewOfFile series interfaces for file memory mapping. For example, a corresponding memory management interface1 is generated in the Dalvik based on a management mode of a virtual memory of the Windows system, and later a memory allocation mechanism of the APP1 in the Dalvik is implemented in the Windows system via the memory management interface1 in the running process of the APP1 based on a Windows-related interface such as VirtualAlloc and on a predetermined memory allocation algorithm.

Preferably, the running unit 112 includes an implementation unit (not shown in the figures) and a multimedia processing unit (not shown in the figures), wherein the implementation unit is configured to implement an OpenGL ES image processing interface and an OpenSL ES audio processing interface used by the Android system based on a DirectX interface and a DirectSound interface of the Windows system; and the multimedia processing unit is configured to control an image frame and an audio frequency by invoking a relevant interface of the DirectX interface of the Windows system.

When processing an image in the Android, hardwares are accelerated by using a set of OpenGL for Embedded Systems (OpenGL ES) standards. For example, when image processing is involved in the running process of the App1, the image is processed in the Dalvik via the OpenGL ES interface. Almost Native Graphics Layer Engine (ANGLE) is a subproject under a Google Chromium open source project, and is a cross-platform OpenGL ES library implemented based on graphical interfaces on respective bottom of Windows/Mac/Linux. In the processing procedure of a CRT, the Windows operating system may invoke DirectX-related interfaces (such as a DirectX9 interface and a DirectX11 interface) of the Windows through the ANGLE to implement relevant interfaces of the OpenGL ES so as to correspondingly process the image, add a customized method for controlling an image frame in the process of processing the DirectX-related interfaces by the CRT so that the App1 runs by an image into which more than 300 frames are filled per second, add a customized word processing method so that the user's real-time barrage message may be displayed in the running process of the App1, and meanwhile add a customized video docking method of an application interface so that an external video may be rapidly and conveniently docked in the running process of the App1.

Preferably, the running unit 112 includes a file IO management unit (not shown in the figures), wherein the file IO management unit determines whether a data structure conversion is needed in a data processing procedure according to a data structure of to-be-processed data, and converts the data structure of the to-be-processed data in the Linux system to a corresponding data structure in the Windows system when the data structure conversion is needed.

The data processing procedure includes: determining a data type, and performing corresponding processing on relevant data whose data type is a file and performing corresponding processing on relevant data whose data type is Socket.

For example, a management mode on the IO in the Linux operating system is different from that on the IO in the Windows operating system. In the Linux operating system, files and USBs or the like are processed as devices. However, processing devices in the Linux operating system are implemented by way of file operation. Therefore, in the processing procedure of a CRT, the data structure of a file in the Linux operating system needs to be customized, so that file operations such as opening, reading or writing the file in the Linux operating system can be implemented in the Windows operating system; and relevant data structures of Socket in the Linux operating system and of relevant device files or the like in the IO need to be customized so that a Socket communication mode in the Linux operating system can be implemented in the Windows operating system. For example, opening a file1 is involved in the running process of the App1, according to a fact that the data structure of the to-be-processed file1 is a file data structure, it is determined that data structure conversion is needed in the processing procedure of the file1, later it is determined that the data type of the file1 is a file, and the data structure of the to-be-processed file1 in the Linux system is converted to a corresponding file data structure in the Windows system.

Optionally, the IO management unit also determines whether a scheduled event occurs in an IO reuse process of the Linux system according to a predetermined detection method.

A Linux thread signal associated with the scheduled event is added, in the IO reuse process, into the Linux system when the scheduled event occurs.

For example, a Linux signal mechanism is involved in the IO reuse process, for example, poll is a function of a character device driver in the Linux, and epoll is a poll improved by the Linux kernel for processing a large batch of file descriptors. In the processing procedures of the poll and the epoll, it is tested whether concerned events occur on file handles concerned by the poll and the epoll by a predetermined test method such as a customized test event function; and once a concerned event occurs, an associated thread is informed to trigger further signal processing.

Preferably, the running unit 112 includes a virtual file system unit configured to convert a file address of the Windows system to a file address corresponding to the Linux system by the virtual file system unit.

The file address includes a relative path and an absolute path of a file.

In the Android, a file system directory such as system or data and an application storage directory generally is stored under a data\app directory or a data\data directory. However, there is no corresponding directory such as the data\app directory or the data\data directory in the Windows, in which files are generally stored under a directory in the form of C:\ or D:\ and so on. In the Windows operating system, a directory corresponding to a data address in the Android that is accessed through an Android application needs to be implemented. Therefore, a Windows directory corresponding to the data address in the Android that is accessed by the Android application from the Windows operating system by a predetermined management method of the virtual file system (for example, by a corresponding management of mapping of a file path through a mapping table) may be implemented. For example, in the running process of the App1 in the Windows, the App1 needs to read a file2, an interface for file operation is opened by invoking a CRT, a relevant interface of a customized virtual file system is invoked, a path address of the file2 in the Windows is converted to a corresponding path address in the Android, and an absolute path address of the file2 in the Windows is obtained by a predefined function (for example, a realpath function) converting a relative path to an absolute path to ensure that the App1 may successfully read the file2 from the Windows.

Optionally, the Android simulator further includes an ARM interpreter configured to interpret an ARM machine language instruction so that the instruction may run on an X86 platform. An implementation method includes but is not limited to implementing an instruction function by using an API at the bottom layer of the Windows, and the ARM instruction function is implemented by reconstructing an intermediate data structure to execute a corresponding X86 instruction or a plurality of X86 instructions.

For example, in the Android, the machine language instruction of the Linux system is converted to a corresponding instruction of an x86 processor of the Windows system so that an Android application may properly run in the Windows operating system of the x86 processor.

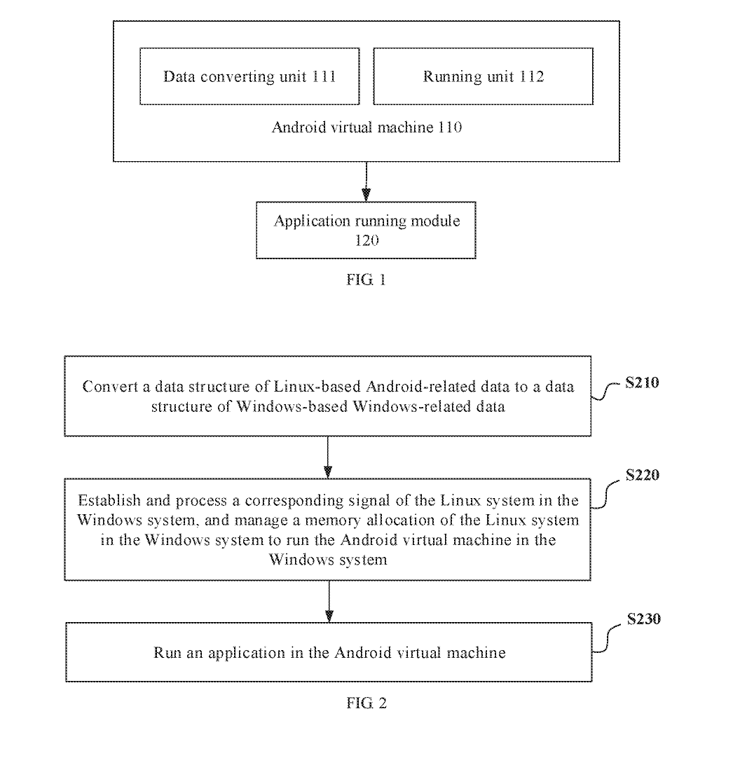

FIG. 2 is a flowchart of a method for implementing an Android simulator according to another embodiment of the present invention.

In this embodiment of the present invention, contents executed in each step are sketched as below: Step S210: converting a data structure of Linux-based Android-related data to a data structure of Windows-based Windows-related data; Step S220: establishing and processing a corresponding signal of the Linux system in the Windows system, and managing a memory allocation of the Linux system in the Windows system to run the Android virtual machine in the Windows system; and Step S230: running an application in the Android virtual machine.

Optionally, after running the Android virtual machine in the Windows system, Step S240 is further included (not shown in the figures); Step S240: loading relevant files of the Android system and of a dynamic link library of the application by loading a Linux executable file of a predetermined format.

Preferably, Step S220 of establishing and processing a corresponding signal of the Linux system in the Windows system specifically includes Step S221 (not shown in the figures), Step S222 (not shown in the figures) and Step S223 (not shown in the figures); Step S221: determining whether to perform signal processing on a currently running thread and a correlation function in the Android simulator based on a preset configuration parameter; Step S222: adding a corresponding Linux signal and a signal processing function into the currently running thread and the correlation function if the determination result is yes; and Step S223: invoking a signal processing function via a predetermined interface of the data converting module according to the corresponding Linux signal of the currently running thread.

The currently running thread includes a thread generated by the Android virtual machine and by the application during a running process, and the correlation function includes but is not limited to a correlation function according with the POSIX standard.

Preferably, Step S220 of managing a memory allocation of the Linux system in the Windows system specifically includes Step S224 (not shown in the figures) and Step S225 (not shown in the figures); Step S224: implementing a memory management interface of the Linux system based on a management mode of a virtual memory of the Windows system; and Step S225: managing a memory allocation of the Linux system in the Windows system via the memory management interface based on a Windows-related interface and a predetermined memory allocation algorithm.

Preferably, Step S220 of establishing and processing a corresponding signal of the Linux system in the Windows system specifically includes Step S226 (not shown in the figures) and Step S227 (not shown in the figures); Step S226: implementing an OpenGL ES image processing interface and an OpenSL ES audio processing interface used by the Android system based on a DirectX interface and a DirectSound interface of the Windows system; and Step S227: controlling an image frame and an audio frequency by invoking a relevant interface of the DirectX interface of the Windows system.

Preferably, Step S220 of establishing and processing a corresponding signal of the Linux system in the Windows system specifically includes Step S228 (not shown in the figures) and Step S229 (not shown in the figures); Step S228: determining whether a data structure conversion is needed in a data processing procedure according to a data structure of to-be-processed data; and Step S229: converting the data structure of the to-be-processed data in the Linux system to a corresponding data structure in the Windows system when the data structure conversion is needed.

The data processing procedure includes: determining a data type, and performing corresponding processing on relevant data whose data type is a file and performing corresponding processing on relevant data whose data type is Socket.

Optionally, the method further includes Step S250 (not shown in the figures) and Step S260 (not shown in the figures); Step S250: determining whether a scheduled event occurs in an IO reuse process of the Linux system according to a predetermined detection method; and Step S260: adding a Linux thread signal associated with the scheduled event in the IO reuse process of the Linux system when the scheduled event occurs.

Preferably, Step S220 of establishing and processing a corresponding signal of the Linux system in the Windows system specifically includes Step S2210 (not shown in the figures); Step S2210: converting a file address of the Windows system to a file address corresponding to the Linux system by the virtual file system unit.

The file address includes a relative path and an absolute path of a file.

Optionally, the method further includes Step S270 (not shown in the figures); S270: converting a machine language instruction of the Linux system to a corresponding instruction of the Windows system.

In the solutions of the present invention, reference may be made to specific implementation theories of various functional modules of the Android simulator according to the embodiment in FIG. 1 for specific function implementations of various steps in the method for implementing an Android simulator, which is not expatiated any more herein.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the method and apparatus and device running in background applied according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

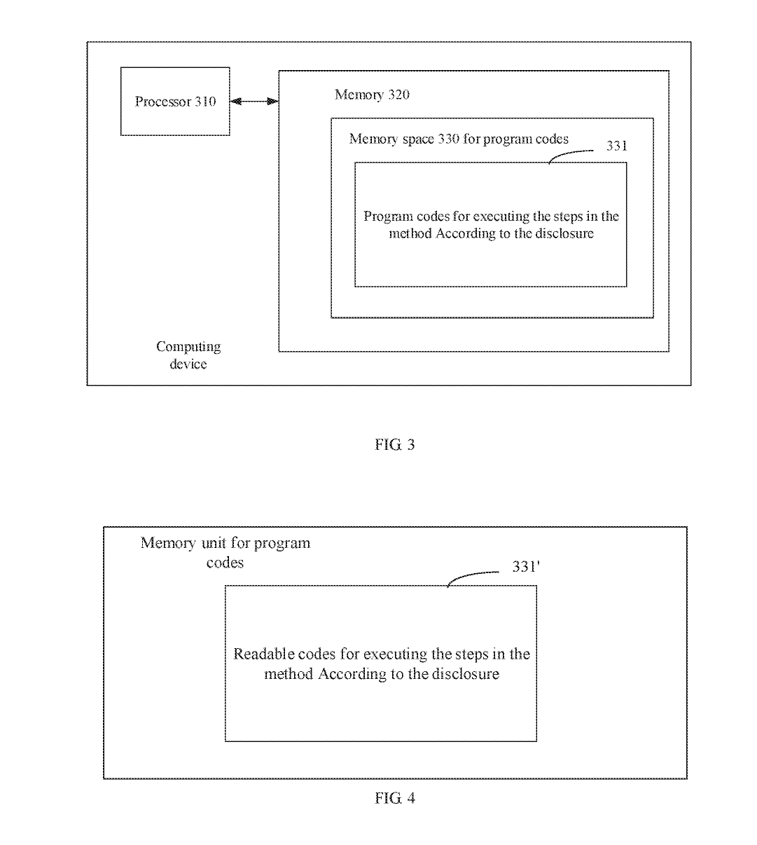

For example, FIG. 3 illustrates a computing device that may implement the method for implementing an Android simulator according to the present invention. Traditionally, the computing device includes a processor 310 and a program product or a computer readable medium in form of a memory 320. The memory 320 could be electronic memories such as flash memory, EEPROM (Electrically Erasable Programmable Read - Only Memory), EPROM or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more program products. These program products include program code carriers such as memory card. These program products are usually the portable or stable memory cells as shown in FIG. 4. The memory cells may be provided with memory sections, memory spaces, etc., similar to the memory 320 of the computing device as shown in FIG. 3. The program codes may be compressed for example in an appropriate form. Usually, the memory cell includes readable codes 331′ which can be read for example by processors 310. When these codes are operated on the computing device, the computing device may execute respective steps in the method as described above.

A person skilled in the art may understand that the present invention includes devices involved for executing one or more of the operations in the application. These devices may be specially designed and manufactured for the required purpose, or may also include known devices in general purpose computers. These devices have computer programs stored therein, which may be selectively activated or reconstructed. Such computer programs may be stored in device (for example, computer) readable medium or in any type of medium suitable for storing electronic instructions and respectively coupled to a bus. The computer readable medium may include but is not limited to any type of disk (including floppy disk, hard disk, optical disks, CD-ROM and magneto-optical disk), Read-Only Memory (ROM), Random Access Memory (RAM), Erasable Programmable Read-Only Memory (EPROM), Electrically Erasable Programmable Read-Only Memory (EEPROM), flash memory, magnetic card or light card. In other words, the readable medium includes any medium for storing or transmitting information in a device (for example, computer) readable form.

A person skilled in the art may understand that each frame in these structure diagrams and/or block diagrams and/or flowcharts and combinations of frames in these structure diagrams and/or block diagrams and/or flowcharts may be implemented by computer program instructions. A person skilled in the art may understand that these computer program instructions may be provided to general-purpose computers, special-purpose computers or other processors of programmable data processing method for implementation, thus executing solutions designated in one or more frames in the structural diagrams and/or the block diagrams and/or the flowcharts disclosed by the present invention by the computers or other processors of programmable data processing method.

A person skilled in the art may understand that the steps, measures and solutions in various operations, methods and flows which have been discussed in the present invention may be alternated, changed, combined or deleted. Further, other steps, measures and solutions in various operations, methods and flows which have been discussed in the present invention may also be alternated, changed, rearranged, decomposed, combined or deleted. Further, the steps, measures and solutions in various operations, methods and flows disclosed in the present invention in the prior art may also be alternated, changed, rearranged, decomposed, combined or deleted.

The above is only a part of implementations of the present invention. It should be pointed out that, for an ordinary person skilled in the art, the present invention may have various improvements and embellishments without departing from the principle of the present invention. These improvements and embellishments should also be regarded as falling into the protection scope of the present invention.

1. A computing device for implementing an Android simulator, comprising:
a memory having instructions stored thereon;
a processor configured to execute the instructions to perform operations for implementing the Android simulator, the operations comprising:
the Android virtual machine comprises a data converting unit and a running unit;
converting a data structure of Linux-based Android-related data to a data structure of Windows-based Windows-related data;
establishing and managing a thread and a signal of the Linux system in the Windows system, and managing a memory allocation of the Linux system in the Windows system; and
running an application in the Android virtual machine running module.

2. The computing device according to claim 1, wherein the operations further comprise: loading relevant files of the Android system and of a dynamic link library of the application by loading a Linux executable file of a predetermined format.

3. The computing device according to claim 1, wherein the operation of establishing and managing a thread and a signal of the Linux system in the Windows system comprises:
determining whether to perform signal processing on a currently running thread and a correlation function in the Android simulator based on a preset configuration parameter;
adding a corresponding Linux signal and a signal processing function into the currently running thread and the correlation function if the determination result is yes; and
invoking a signal processing function via a predetermined interface according to the corresponding Linux signal of the currently running thread; wherein
the currently running thread comprises a thread generated by the Android virtual machine and by the application during a running process, and the correlation function comprises but is not limited to a correlation function according with a POSIX standard.

4. The computing device according to claim 1, wherein the operation of managing a memory allocation of the Linux system in the Windows system comprises:
implementing a memory management interface of the Linux system based on a management mode of a virtual memory of the Windows system; and
managing a memory allocation of the Linux system in the Windows system via the memory management interface based on a Windows-related interface and a predetermined memory allocation algorithm.

5. The computing device according to claim 1, wherein the operation of establishing and processing a corresponding signal of the Linux system in the Windows system comprises:
implementing an OpenGL ES image processing interface and an OpenSL ES audio processing interface used by the Android system based on a DirectX interface and a DirectSound interface of the Windows system; and
controlling an image frame and an audio frequency by invoking a relevant interface of the DirectX interface of the Windows system.

6. The computing device according to claim 1, wherein the operation of establishing and processing a corresponding signal of the Linux system in the Windows system comprises:
determining whether a data structure conversion is needed in a data processing procedure according to a data structure of to-be-processed data; and
converting the data structure of the to-be-processed data in the Linux system to a corresponding data structure in the Windows system when the data structure conversion is needed, wherein
the data processing procedure comprises: determining a data type, and performing corresponding processing on relevant data whose data type is a file and on relevant data whose data type is Socket.

7. The computing device according to claim 6, wherein the operation of establishing and processing a corresponding signal of the Linux system in the Windows system further comprises:
determining whether a scheduled event occurs in an IO reuse process of the Linux system according to a predetermined detection method; and
adding a Linux thread signal associated with the scheduled event in the IO reuse process of the Linux system when the scheduled event occurs.

8. The computing device according to claim 1, wherein the operation of establishing and processing a corresponding signal of the Linux system in the Windows system comprises converting a file address of the Windows system to a file address corresponding to the Linux system; wherein
the file address comprises a relative path and an absolute path of a file.

9. The computing devices according to claim 1, wherein the operations further comprise:
converting a machine language instruction of the Linux system to a corresponding instruction of the Windows system.

10. A method for implementing an Android simulator, comprising:
converting a data structure of Linux-based Android-related data to a data structure of Windows-based Windows-related data;
establishing and processing a corresponding signal of the Linux system in the Windows system and managing a memory allocation of the Linux system in the Windows system to run an Android virtual machine in the Windows system; and
running an application in the Android virtual machine.

11. The method according to claim 10, wherein after running the Android virtual machine in the Windows system, the method further comprises:
loading relevant files of the Android system and of a dynamic link library of the application by loading a Linux executable file of a predetermined format.

12. The method according to claim 10, wherein the establishing and processing a corresponding signal of the Linux system in the Windows system comprises:
determining whether to perform signal processing on a currently running thread and a correlation function in the Android simulator based on a preset configuration parameter;
adding a corresponding Linux signal and a signal processing function into the currently running thread and the correlation function if the determination result is yes; and
invoking a signal processing function via a predetermined interface according to the corresponding Linux signal of the currently running thread; wherein
the currently running thread comprises a thread generated by the Android virtual machine and by the application during a running process, and the correlation function comprises but is not limited to a correlation function according with a POSIX standard.

13. The method according to claim 10, wherein the managing a memory allocation of the Linux system in the Windows system comprises:
implementing a memory management interface of the Linux system based on a management mode of a virtual memory of the Windows system; and
managing a memory allocation of the Linux system in the Windows system via the memory management interface based on a Windows-related interface and a predetermined memory allocation algorithm.

14. The method according to claim 10, wherein the establishing and processing a corresponding signal of the Linux system in the Windows system comprises:
implementing an OpenGL ES image processing interface and an OpenSL ES audio processing interface used by the Android system based on a DirectX interface and a DirectSound interface of the Windows system; and
controlling an image frame and an audio frequency by invoking a relevant interface of the DirectX interface of the Windows system.

15. The method according to claim 10, wherein the establishing and processing a corresponding signal of the Linux system in the Windows system comprises:
determining whether a data structure conversion is needed in a data processing procedure according to a data structure of to-be-processed data; and
converting the data structure of the to-be-processed data in the Linux system to a corresponding data structure in the Windows system when the data structure conversion is needed, wherein
the data processing procedure comprises: determining a data type, and performing corresponding processing on relevant data whose data type is a file and performing corresponding processing on relevant data whose data type is Socket.

16. The method according to claim 15, further comprising:
determining whether a scheduled event occurs in an TO reuse process of the Linux system according to a predetermined detection method; and
adding a Linux thread signal associated with the scheduled event in the TO reuse process of the Linux system when the scheduled event occurs.

17. The method according to claim 10, wherein the establishing and processing a corresponding signal of the Linux system in the Windows system comprises:
converting a file address of the Windows system to a file address corresponding to the Linux system by the virtual file system unit; wherein
the file address comprises a relative path and an absolute path of a file.

18. The method according to claim 10, further comprising:
converting a machine language instruction of the Linux system to a corresponding instruction of the Windows system.

19. (canceled)

20. A non-transitory computer-readable medium, having computer programs stored thereon that, when executed by one or more processors of a computing device, cause the computing device to perform operations for implementing an Android simulator, the operations comprising:
converting a data structure of Linux-based Android-related data to a data structure of Windows-based Windows-related data;
establishing and processing a corresponding signal of the Linux system in the Windows system and managing a memory allocation of the Linux system in the Windows system to run an Android virtual machine in the Windows system; and
running an application in the Android virtual machine.

21. The non-transitory computer-readable medium according to claim 20, wherein the operations further comprise:
loading relevant files of the Android system and of a dynamic link library of the application by loading a Linux executable file of a predetermined format.
